(19) United States
(12) Patent Application Publication
(10) Pub. No.: US 2019/0215569 A1
(43) Pub. Date: Jul. 11, 2019

(54) CHANNEL PROCESSING METHOD FOR SMART TV, AND SMART TV

(71) Applicants: Qingdao Hisense Electronics Co., Ltd., Qingdao (CN); Hisense International Co., Ltd., Qingdao (CN); Hisense Electronics Technology (Shenzhen) Co., Ltd., Shenzhen (CN)

(72) Inventor: Gaoling LIU, Qingdao (CN)

(73) Assignees: Qingdao Hisense Electronics Co., Ltd., Qingdao (CN); Hisense International Co., Ltd., Qingdao (CN); Hisense Electronics Technology (Shenzhen) Co., Ltd ., Shenzhen (CN)

(21) Appl. No.: 15/938,566

(22) Filed: Mar. 28, 2018

Related U.S. Application Data
(63) Continuation of application No. PCT/CN2018/071812, filed on Jan. 8, 2018.

(51) Int. Cl. H04N 21/475; H04N 21/4627

(52) U.S. Cl. CPC H04N 21/4753; H04N 21/4627

(57) ABSTRACT

A channel processing method for a smart TV, and a smart TV for channel processing are disclosed. The channel processing method includes determining a currently started channel of a smart TV, determining whether the currently started channel is a virtual channel obtained by virtualizing an application running on the smart TV, and starting the application corresponding the virtual channel and obtaining content played on the smart TV from network in response to that the currently started channel is a virtual channel. A channel generated by virtualizing an application running on the smart TV is used as a channel started upon turn-on of a smart TV, so that the application can be directly started when the smart TV is turned on, and then video content provided by the application is played.

### CROSS-REFERENCE TO RELATED APPLICATION(S)

This application is a continuation of International Patent Application No. PCT/CN2018/071812, filed Jan. 8, 2018, the entirety of which is hereby incorporated by reference herein.

### BACKGROUND

### Technical Field

The present disclosure relates to the field of smart TV technologies, and in particular, to a channel processing method for a smart TV, and a smart TV.

### Related Art

Currently, network applications such as network broadcast and audio and video applications have become primary channels when a user watches a smart TV. However, in a related technology, all network applications usually are integrated into one page, and when a user opens a particular application, the user has to search for the application only through the use of page up and page down operations on the integrated page. As a result, the operation steps required are tedious, and the processing method cannot satisfy a user requirement, especially when there are many applications.

### SUMMARY

The present disclosure provides a channel processing method for a smart TV, as well as a smart TV for implementing the method, to resolve a problem that operation steps of opening, by a user, an application in a smart TV are complex.

According to a first embodiment, the present disclosure provides a channel processing method for a smart TV, including determining a currently started channel of a smart TV, determining whether the currently started channel is a virtual channel generated by virtualizing an application running on the smart TV, and in response to a determination that the currently started channel is a virtual channel, start an application corresponding to the virtual channel and obtain content to be played on the smart TV from network based on the application.

According to some embodiments, determining the currently started channel of a smart TV may include, after the smart TV is turned on, determining whether a default channel is set in a channel list of the smart TV, and in response to a determination that a default channel is set in the channel list, starting the default channel, and determining the started default channel as the currently started channel, or in response to a determination that no default channel is set in the channel list, starting a channel used during previous turn-on of the smart TV, and determining the channel used during the previous turn-on of the smart TV as the currently started channel.

According to some embodiments, before determining whether a default channel is set for the smart TV, the method may further include obtaining a channel list update message from a server or an external device, where the channel list update message includes a virtual channel newly configured by the server or the external device, and updating the channel list of the smart TV according to the channel list update message.

According to some embodiments, before determining whether the currently started channel is a virtual channel, the method may further include determining whether a codeword is set for the currently started channel, and in response to a determination that a codeword is set, prompting a user to enter a codeword, receiving the codeword entered by the user, and verifying the codeword entered by the user.

According to some embodiments, the method may further include in response to a determination that the currently started channel is not a virtual channel, obtaining content to be played on the smart TV from network through an external device.

According to a second embodiment, the present disclosure provides a smart TV, including a processor and a memory, where the memory comprising computer instructions stored therein, and the processor is configured to execute the computer instructions in the memory to: determine a currently started channel of a smart TV, determine whether the currently started channel is a virtual channel generated by virtualizing an application running on the smart TV, and in response to a determination that the currently started channel is a virtual channel, start an application corresponding to the virtual channel and obtain content to be played on the smart TV from network based on the application.

According to some embodiments, the processor is configured to execute the computer instructions to: determine the currently started channel of the smart TV by, after the smart TV is turned on, determining whether a default channel is set in a channel list of the smart TV, and in response to a determination that a default channel is set in the channel list, starting the default channel, and determining the started default channel as the currently started channel, or in response to a determination that no default channel is set in the channel list, starting a channel used during previous turn-on of the smart TV, and determining the channel used during the previous turn-on as the currently started channel.

According to some embodiments, the processor is further configured to execute the computer instructions in the memory to, before determining whether a default channel is set for the smart TV, obtain a channel list update message from a server or an external device, where the channel list update message includes a virtual channel newly configured by the server or the external device, and update the channel list of the smart TV according to the channel list update message.

According to some embodiments, the processor is further configured to execute the computer instructions in the memory to, before determining whether the currently started channel is a virtual channel, determine whether a codeword is set for the currently started channel, and in response to a determination that a codeword is set, prompt a user to enter a codeword, receive the codeword entered by the user, and verify the codeword entered by the user.

According to some embodiments, the processor is further configured to execute the computer instructions in the memory to obtain content to be played on the smart TV from network through an external device in response to a determination that the currently started channel is not a virtual channel.

According to a third embodiment, the present disclosure provides a computer readable non-volatile storage medium, where the computer readable non-volatile storage medium having computer instructions stored thereon, and the computer instructions when executed on a processor to perform the method described in the first embodiment.

According to a fourth embodiment, the present disclosure provides a computer program product, where the computer program product includes computer programs stored in a computer readable storage medium, the computer programs include program instructions, and when a computer device executes the program instructions, the computer device performs the method described in the first embodiment.

### BRIEF DESCRIPTION OF THE DRAWINGS

One or more embodiments are described exemplarily by using figures in the accompanying drawings, and the exemplary descriptions shall not be considered as a limitation to the embodiments. Elements having similar reference numerals in the accompanying drawings represent the same, and/or, similar elements. Unless otherwise specified, the figures in the accompanying drawings are not necessarily proportional.

FIG. 1 is a schematic flowchart of an exemplary channel processing method for a smart TV according to the present disclosure;

FIG. 2 is a schematic diagram of an exemplary channel list according to the present disclosure;

FIG. 3 is a schematic diagram of exemplary prompt information according to the present disclosure;

FIG. 4 is a schematic flowchart of an exemplary channel processing method for a smart TV according to the present disclosure; and

FIG. 5 is a schematic structural diagram of an exemplary smart TV according to the present disclosure.

### DETAILED DESCRIPTION

To make the objectives, technical solutions, and advantages of the present disclosure clearer, the following further describes in detail the present disclosure with reference to specific embodiments and accompanying drawings. It should be understood that the descriptions are exemplary, and are not intended to limit the scope of the features described in this disclosure. In addition, descriptions of commonly known structures and technologies may be omitted in the following description, to avoid unnecessary confusion about the present disclosure.

In the present disclosure, a smart TV may be a television configured to run one or more applications and have an operating system to manage these applications. A smart TV may also include wireless, or wired, interfaces for communicating with remote devices.

In a smart TV, a user chooses a desired signal source, for example, high definition multimedia interface (HDMI), high definition, audio and video (AV), and universal serial bus (USB), by means of a channel list. However, when a user opens a desired application through an application list, operations are complex and it is inconvenient for the user. In addition, remote controls of users tend to be more simplified, and with a rapid increase of a number of network applications, a manner of opening an application rapidly by a shortcut key on a remote control cannot satisfy user's requirements. Furthermore, as network broadcast television applications are becoming more popular, the conventional implementation where a broadcast signal can only be watched through a television tuner no longer applies. The network application in some sense is equivalent to a conventional physical channel, except that the network application obtains content from a network.

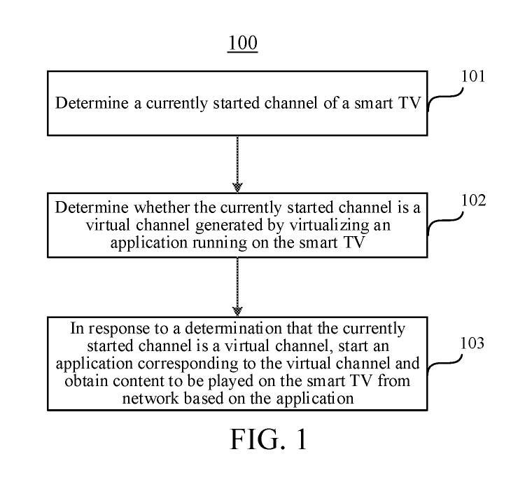

Referring to FIG. 1, FIG. 1 shows an exemplary flowchart 100 describing a method for channel processing according to the present disclosure. The method may be performed, for example, by a smart TV. As shown in FIG. 1, the method includes the following specific steps.

Step 101, determine a currently started channel of a smart TV.

First, the smart TV determines a channel that has been started and is being played on the screen, as the currently started channel. The channel may be a default channel. A user may set a default channel started for each turn-on event for the smart TV, for example, an HDMI channel is started each time by default, that is, a channel in connection with an external device via an HDMI connector is started. In addition or alternatively, a virtual channel is started each time by default, and a network application is started. The virtual channel is a channel generated by regarding a network application as a channel in some sense equivalent to HDMI channel. The virtual channel may be added to a channel list, for example, the channel list 200 shown in FIG. 2. The channel list 200 includes a virtual channel 1, a virtual channel 2, HDMI 1, HDMI 2, USB 1, USB 2, AV, and the like. The virtual channel 1 is set as a default channel.

The process for determining a currently started channel may specifically include: after the smart TV is turned on, determining whether a default channel is set in a channel list of the smart TV; and when a default channel is set in the channel list, starting the default channel, and determining the started default channel as the currently started channel. When no default channel is set in the channel list, the process for determining a currently started channel may include starting a channel used during previous turn-on of the smart TV, and determining the channel used during the previous turn-on of the smart TV as the currently started channel. If no default channel is set in the channel list, the channel used during previous turn-on of the smart TV may be used. For example, the channel used before last turn-off is the virtual channel 1, and it is determined, after the smart TV is turned on, that no default channel is set. In this case, the virtual channel 1 is started, and the virtual channel 1 is the currently started channel.

To improve user experience, a default channel input by a user may alternatively be received, and a channel to be started during turn-on of the smart TV is set according to the default channel input by the user.

Before the currently started channel is determined, a channel list update message may further be obtained or received from a server or an external device, and the channel list of the smart TV is updated according to the channel list update message. The channel list update message may include a virtual channel newly configured by the server or the external device. That is, after the smart TV is turned on, the smart TV is connected to a network, and exchanges information with the server or the external device, to receive messages associated with the virtual channel newly configured by the user. The channel list update message may further include information about the virtual channel, for example, a name, a uniform resource locator (URL), and a location in the channel list. The external device may be a set top box of a cable TV or another network set top box connected to an external interface on the smart TV.

It should be noted that in present disclosure, a number of virtual channels in the channel list may increase or decrease, and an application corresponding to each virtual channel may be changed.

Step 102, determine whether the currently started channel is a virtual channel generated by virtualizing an application running on the smart TV.

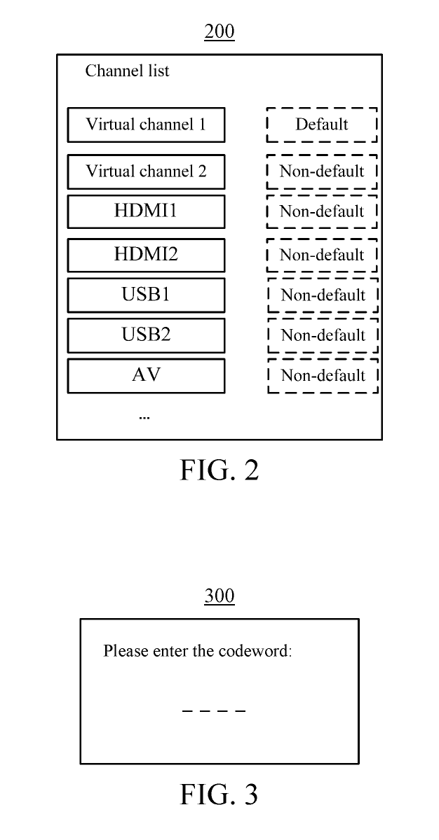

In some embodiments, to protect the privacy of the user, before it is determined whether the currently started channel is a virtual channel, it may be further determined whether a codeword is set for the currently started channel, and when a codeword is set, the user is prompted to enter the codeword. For example, “Please enter the codeword” is displayed on a screen 300 to the user, as shown in FIG. 3. As shown in FIG. 3, after the codeword entered by the user is received, the codeword entered by the user is verified, and after the codeword is authenticated, the smart TV determines whether the currently started channel is a virtual channel. In this way, use of the application can be limited or permission can be assigned to a particular user with codeword.

Step 103, in response to a determination that the currently started channel is a virtual channel, start an application corresponding to the virtual channel and obtain content to be played on the smart TV from network based on the application.

When it is determined in step 102 that the currently started channel is a virtual channel, an application corresponding to the virtual channel is to be started, and content to be played on the smart TV is obtained from a network, such as a network server which provides service for the application. Therefore, tedious steps caused by switching of applications in the integrated page can be avoided.

When it is determined in step 102 that the currently started channel is not a virtual channel, content provided by the external device can be directly displayed. That is, the content to played by the smart TV is obtained by means of the external device.

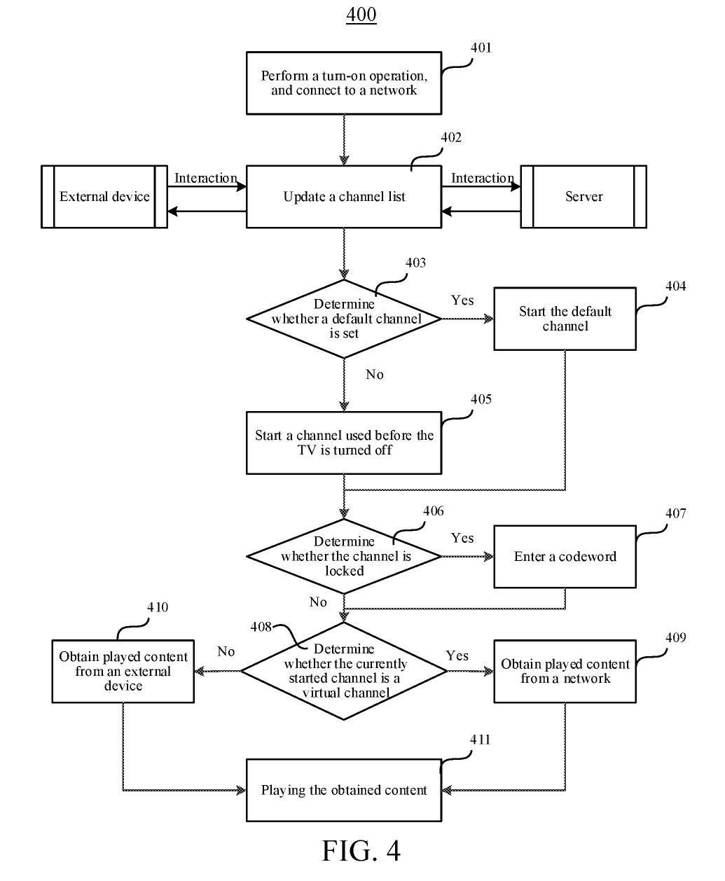

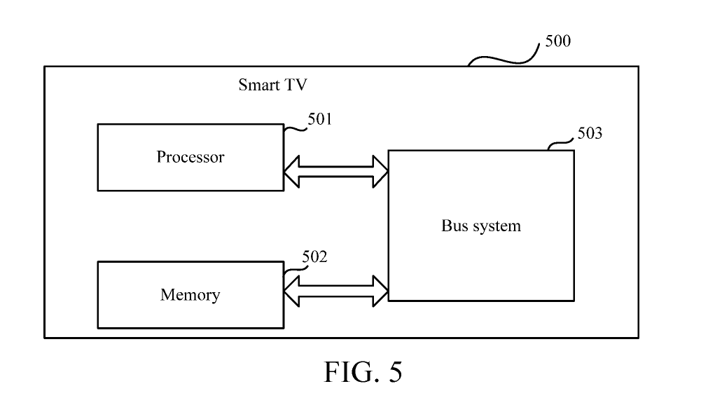

To better explain the channel management process provided in the present disclosure, the following flowchart 400 shown in FIG. 4 gives a description with reference to a specific implementation scenario. As shown in FIG. 4, the method specifically includes:

Step 401, perform a turn-on operation, and connect to a network.

When a smart TV is turned on, the smart TV is first connected to the network.

Step 402. Update a channel list.

A conventional physical channel list of the smart TV is in a one-to-one correspondence to hardware of the television, and cannot be added or changed. After an application is used as a virtual channel in the present disclosure, because the application itself has a particular URL, different icons and URLs may be configured by a server to change or add a virtual channel. The flexible operation manner not only can provide a value-added service for a user, but also can improve the user experience of the product.

Compared with the conventional physical channel list, when a channel list having virtual channels is updated, except procedures that the current channel is ranked first and a channel having a signal is placed in the front row, there is an additional procedure to inquiry about whether there is a newly configured virtual channel from the server. Each time the user opens the channel list, the smart TV communicates with a server or an external device, to discover whether there is a newly configured virtual channel, a name of the virtual channel, a location of the virtual channel in the channel list, and a URL of the virtual channel, to automatically update the channel list of the smart TV.

Step 403, determine whether a default channel is set, and if a default channel is set, perform step 404, or if no default channel is set, perform step 405.

For some smart TVs, after the smart TVs are turned on, physical channels, for example, HDMI, are entered preferentially. A solution for opening an application upon turn-on is: An application opened before a television is turned off is marked, and after the television is turned on, the smart TV pops up a prompt to allow the user to choose whether to enter the application opened before the television is turned off. In the present disclosure, a network application is used as a virtual channel, like a physical channel. A virtual channel opened before the television is turned off can be marked, and the virtual channel is directly entered after the television is turned on. The following is two exemplary approaches of entering a virtual channel:

1. If a virtual channel is being watched during the last turn-on, the virtual channel is directly entered after turn-on.

2. Set a virtual channel as a default start channel, and in this way, enter the set virtual channel each time after the smart TV is turned on.

Step 404. Start the default channel.

When it is determined that a default channel is set, the default channel is directly started.

Step 405. Start a channel used before the TV is turned off.

When it is determined that no default channel is set, the channel used before the TV is turned off, i.e., the channel opened during previous turn-on, is started.

Step 406. Determine whether the channel is locked, and if the channel is locked, perform step 407, or if the channel is not locked, perform step 408.

Step 407. Enter a codeword.

The TV pops up a message to prompt a user to enter the codeword if the channel (for example, some channel not suitable for children) is locked, then it verifies whether the codeword is correct, and step 408 is performed when the codeword is authenticated.

A predetermined codeword (for example, 4-digit codeword) may be set for the virtual channel by means of a setting menu, and the correct codeword needs to be entered during turn-on or when the virtual channel is switched to, or otherwise, the virtual channel cannot be opened, so that use of the application is limited or permission is assigned to a particular user, thereby helping limit particular users access unsuitable channels.

Step 408. Determine whether the currently started channel is a virtual channel, and if the currently started channel is a virtual channel, perform step 409, or if the currently started channel is not a virtual channel, perform step 410.

Step 409. Obtain played content from a network.

The smart TV starts the application corresponding to the virtual channel, to obtain the played content from the network.

Step 410. Obtain played content from an external device.

The smart TV starts the external device, and obtains the played content by the external device.

Step 411. Playing the obtained content.

As indicated in the foregoing embodiment, when the currently started channel of the smart TV has been determined, it is further determined whether the currently started channel is a virtual channel obtained by virtualizing an application running on the smart TV, and when the currently started channel is a virtual channel, an application corresponding to the virtual channel is started and the content played by the smart TV is obtained from network based on the application. A channel obtained by virtualizing an application is used as a channel started upon turn-on of a smart TV, so that the application can be directly started when the smart TV is turned on, and corresponding video content is played, without making great efforts to look for a particular application among many applications on a integrated page.

Based on a same technical concept, the present disclosure provides a smart TV. In a structure of the smart TV 500 shown in FIG. 5, the smart TV 500 includes a processor 501 and a memory 502, and the processor 501 and the memory 503 are connected by a bus system 503.

The memory 502 is configured to store computer programs. Specifically, the programs may include computer instructions. The memory 502 may be a random access memory (RAM), or may be a non-volatile memory, for example, at least one magnetic memory. Although the smart TV 500 is shown to include one memory 502, the memory 502 may be representative of one or more memories set according to requirements. The memory 502 may be a memory in the processor 501.

The memory 502 stores the following elements, executable modules or data structures, or subsets thereof, or extension sets thereof. Various operation instructions are used to implement various operations. An operating system may include various system programs, used to implement various fundamental services and process hardware-based tasks.

The channel processing method for a smart TV in the present disclosure may be implemented by the processor 501. The processor 501 may be an integrated circuit chip and has the ability to do signal processing. In an implementation process, steps of the channel processing method for a smart TV may be implemented by a hardware integrated logic circuit in the processor 501 combined with software in the form of instructions. The processor 501 may be a general purpose processor, a digital signal processor (DSP), an application-specific integrated circuit (ASIC), a field programmable gate array (FPGA) or another programmable logical device, a discrete gate or transistor logic device, or a discrete hardware component. The method, steps, and logic block diagrams in the present disclosure may be implemented or executed. The general-purpose processor may be a microprocessor, or the processor may be any conventional processor, or the like. The steps of the method in the present disclosure may be performed by a hardware decoding processor, or may be performed by a combination of hardware and software modules in the decoding processor. The software module may be located in a mature storage medium in the field, such as a RAM, a flash memory, a read-only memory (ROM), a programmable ROM, an electrically-erasable programmable memory, or a register. The memory 502 has computer instructions stored therein, and the processor 501 is configured to execute the computer instructions in the memory 502 to implement any of the processes described herein. For example, the processor 501 is configured to execute the computer instruction in the memory 502 to:

determine a currently started channel of a smart TV;

determine whether the currently started channel is a virtual channel generated by virtualizing an application running on the smart TV; and

in response to a determination that the currently started channel is a virtual channel, start an application corresponding to the virtual channel and obtain content to be played on the smart TV from network based on the application.

Optionally, the processor 501 determines the currently started channel of the smart TV by the following processes:

after the smart TV is turned on, determining whether a default channel is set in a channel list of the smart TV; and

when a default channel is set in the channel list, starting the default channel, and determining the started default channel as the currently started channel; or

when no default channel is set in the channel list, starting a channel used during previous turn-on of the smart TV, and determining the channel used during the previous turn-on of the smart TV as the currently started channel.

Optionally, the processor 501 is further configured to execute the computer instructions in the memory 502 to:

before determining whether a default channel is set for the smart TV, obtain a channel list update message from a server or an external device, where the channel list update message includes a virtual channel newly configured by the server or the external device; and

update the channel list of the smart TV according to the channel list update message.

Optionally, the processor 501 is further configured to execute the computer instruction in the memory 502 to:

before determining whether the currently started channel is a virtual channel, determine whether a codeword is set for the currently started channel; and

when a codeword is set, prompt a user to enter a codeword, receive the codeword entered by the user, and verify the codeword entered by the user.

Optionally, the processor 501 is further configured to execute the computer instructions in the memory 502 to:

obtain, through an external device when the currently started channel is not a virtual channel, content played on the smart TV.

A person skilled in art may understand that all or some steps of the channel processing method for a smart TV provided in the foregoing embodiments may be implemented by a program instructing related hardware. The program is stored in a storage medium, and includes instructions to enable a device (which may be a single chip, a chip, or the like) or a processor to perform all or some steps of the method in the embodiments of the present disclosure. The foregoing storage medium includes: any medium that can store program code, such as a USB flash drive, a ROM, a RAM, a removable hard disk, a magnetic disk, or an optical disc.

In addition, the present disclosure further provides a computer readable non-volatile storage medium, where the computer readable non-volatile storage medium comprises computer instructions stored thereon, and the computer instructions when executed on a processor perform the channel processing method for a smart television described above.

In addition, the present disclosure further provides a computer program product, where the computer program product includes computer programs stored on a computer readable storage medium, the computer programs includes program instructions, and when a computer executes the program instructions, the computer performs the channel processing method for a smart television described above.

The present disclosure is described with reference to the method, the device (system), and the flowchart and/or block diagram of a computer program product provided in the present disclosure. It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although the embodiments of the present disclosure have been described, a person skilled in the art can make additional changes and modifications to these embodiments once knowing a basic creative concept. Therefore, the appended claims intend to include the preferred embodiments and all changes and modifications falling within the scope of the present disclosure.

Apparently, a person skilled in the art may make various changes and modifications to the present disclosure without departing from the spirit and scope of the present disclosure. In this way, if the modifications and variations of the present disclosure belong to the claims of the present disclosure and the scope of the equivalent technology, the present disclosure intends to include the changes and variations.

1. A method for channel processing on a smart TV, the method comprising:
obtaining, from a server, a channel list update message including a virtual channel newly configured by the server;
updating a channel list of the smart TV to include the virtual channel;
determining a currently started channel of a smart TV;
determining whether the currently started channel is the virtual channel, wherein the virtual channel is generated by virtualizing an application running on the smart TV;
in response to a determination that the currently started channel is a virtual channel, communicating, through a network, with an application hosting server; and
executing, on the smart TV, the application corresponding to the virtual channel, wherein executing the application comprises:
obtaining, from the application hosting server, displayable content corresponding to the application; and
displaying, on the smart TV, the displayable content on the virtual channel.

2. The method according to claim 1, wherein said determining the currently started channel of the smart TV comprises:
after the smart TV is turned on, determining whether a default channel is set in a channel list of the smart TV;
in response to a determination that a default channel is set in the channel list, starting the default channel, and setting the default channel as the currently started channel; and
in response to a determination that no default channel is set in the channel list, starting a channel used during a previous turn-on of the smart TV, and determining the channel used during the previous turn-on of the smart TV as the currently started channel.

3. (canceled)

4. The method according to claim 1, wherein before determining whether the currently started channel is a virtual channel, the method further comprises:
determining whether a codeword is set for the currently started channel; and
in response to a determination that the codeword is set:
prompting entering of a codeword;
receiving the codeword; and
verifying the codeword.

5. The method according to claim 1, wherein the method further comprises:
in response to that the currently started channel is not a virtual channel, obtaining content to be played on the smart TV through an external device.

6. A smart TV, comprising a processor and a memory, wherein the memory stores processor executable instructions configured to, when executed by the processor, cause the processor to:
obtain, from a server, a channel list update message including a virtual channel newly configured by the server;
update a channel list of the smart TV to include the virtual channel;
determine a currently started channel of the smart TV;
determine whether the currently started channel is the virtual channel, wherein the virtual channel is generated by virtualizing an application running on the smart TV; and
in response to a determination that the currently started channel is a virtual channel, communicate, through a network, with an application hosting server;
execute, on the smart TV, the application corresponding to the virtual channel;
obtain, from the application hosting server, displayable content corresponding to the application; and
display, on the smart TV, the displayable content on the virtual channel.

7. The smart TV according to claim 6, wherein the instructions, when executed by the processor, cause the processor to determine the currently started channel of the smart TV by:
after the smart TV is turned on, determining whether a default channel is set in a channel list of the smart TV; and
in response to a determination that a default channel is set in the channel list, starting the default channel, and setting the default channel as the currently started channel; and
in response to a determination that no default channel is set in the channel list, starting a channel used during a previous turn-on of current turn-on of the smart TV, and determining the channel used during the previous turn-on of the smart TV as the currently started channel.

8. (canceled)

9. The smart TV according to claim 6, wherein the instructions, when executed by the processor, further cause the processor to:
before determining whether the currently started channel is a virtual channel, determine whether a codeword is set for the currently started channel; and
in response to a determination that a codeword is set:
prompt entering of a codeword;
receive the codeword; and
verify the codeword.

10. The smart TV according to claim 6, wherein the instructions, when executed by the processor, further cause the processor to:
in response to that the currently started channel is not a virtual channel, obtaining content to be played on the smart TV through an external device.

11. A machine-readable medium, other than a transitory signal, the machine-readable medium storing instructions configured to, when executed, cause a processor to:
obtain, from a server, a channel list update message including a virtual channel newly configured by the server;
update a channel list of the smart TV to include the virtual channel;
determine a currently started channel of a smart TV;
determine whether the currently started channel is the virtual channel, wherein the virtual channel is generated by virtualizing an application running on the smart TV; and
in response to a determination that the currently started channel is the virtual channel, communicate, through a network, with an application hosting server;
execute, on the smart TV, the application corresponding to the virtual channel;
obtain, from the application hosting server, displayable content corresponding to the application; and
display, on the smart TV, the displayable content on the virtual channel.

12. The machine-readable medium according to claim 11, wherein the instructions, when executed by the processor, cause the processor to determine the currently started channel of the smart TV by:
after the smart TV is turned on, determining whether a default channel is set in a channel list of the smart TV; and
in response to a determination that a default channel is set in the channel list, starting the default channel, and setting the default channel as the currently started channel; and
in response to a determination that no default channel is set in the channel list, starting a channel used during a previous turn-on of current turn-on of the smart TV, and determining the channel used during the previous turn-on of the smart TV as the currently started channel.

13. (canceled)

14. The machine-readable medium according to claim 11, wherein the instructions, when executed by the processor, further cause the processor to:
before determining whether the currently started channel is a virtual channel, determine whether a codeword is set for the currently started channel; and
in response to a determination that a codeword is set:
prompt entering of a codeword;
receive the codeword; and
verify the codeword.

15. The machine-readable medium according to claim 11, wherein the instructions, when executed by the processor, further cause the processor to:
obtain content to be played on the smart TV through an external device in response to a determination that the currently started channel is not a virtual channel.
